(19) United States
(12) Patent Application Publication
(10) Pub. No.: US 2016/0267825 A1
(43) Pub. Date: Sep. 15, 2016

(54) System for creating aerial designs and messages

(71) Applicant: Michael Wayne Stewart, Gold Hill, NC (US)

(72) Inventor: Michael Wayne Stewart, Gold Hill, NC (US)

(21) Appl. No.: 14/644,381

(22) Filed: Mar. 11, 2015

(51) Int. Cl. G09F 21/16; B64D 1/20; G08G 5/00

(52) U.S. Cl. CPC G09F 21/16; G08G 5/0047; B64D 1/20

(57) ABSTRACT

One embodiment of an aerial messaging and design system consisting of a computer, GPS, relay switch, fluid solenoid switch, fluid, fluid pump, check valve, and fluid injector. The system uses one or more aircraft whereby the computer controls the relay switch to produce smoke. When the switch is activated, the switch opens the fluid solenoid, allowing fluid to be injected into the hot exhaust of the airplane creating dots or lines of smoke. Each aircraft equipped with this machine system, is able to operate autonomously, free from any inter-plane communications. With aircraft operating autonomously, they are free to fly independently from one another, in or not in formation, creating messages and designs that are complex and 3-dimensional. Other embodiments are described and shown. See FIG. 1 in the drawings for a system layout.

### CROSS-REFERENCE TO RELATED APPLICATIONS

None

### FEDERALLY SPONSORED RESEARCH

None

### SEQUENCE LISTING OR PROGRAM

None

### BACKGROUND OF THE INVENTION

1. Field

This application related to the methods and systems for creating aerial messaging and designs through the use of multiple aircraft and smoke systems.

2. Prior Art

Aerial messaging systems have been around for decades. It's a method of delivering messages in the air through the use of either a single aircraft for sykwriting, or multiple aircraft, often called skytyping. Whether a single or multiple aircraft, these messages can be seen for many miles.

Skywriting is limited by the pilots ability to fly the plane very precisely to make letters. This can take a long time to write out a word or design. Winds and other factors, can quickly dissipate the smoke, leaving the viewers from the ground wondering what was actually being said or displayed. Simply a single aircraft can't write fast enough in most cases to complete a word, or sentence.

To improve the feasibility and ease of creating aerial messages, aviators began using multiple aircraft flying in formation to create messages, with each aircraft emitting short “puffs” of vapor or smoke in a defined pattern to form the individual characters (e.g., letters, numbers, etc.) of the messages. The resulting messages, which are created within a single pass, look like the printouts from a low resolution dot-matrix printer, with individual characters being formed by a pattern of smoke puffs that resembles the pattern of ink dots produced on paper by a dot-matrix printer. Thus, rather than “writing” aerial messages using only a single aircraft, the messages are “printed” in the sky using five or more aircraft, with each aircraft contributing a portion of each character.

Previous systems, as discussed U.S. Pat. No. 7,082,706, requires the use of a main or master computational device connected via a physical or wireless network connection, to multiple control boxes (also computational devices) located in each aircraft. Each control box is connected to a smoke system installed in its respective aircraft, which allows the control boxes to control the emission of smoke puffs from the aircraft. Software running on the master computational device is used to coordinate the vapor puffs by sending data to and receiving data from each of the control boxes. These previous systems have several limitations, primarily in the requirement of a master computer communicating to slave devices, as well as a communication network for the system to function.

This application machine system consists of a computer, GPS, relay switch, fluid solenoid switch, fluid, fluid pump, EFIS (Electronic Flight Information System) (optional), check valve, and fluid injector. The computer controls the relay switch. When the switch is activated, the switch opens the fluid solenoid, allowing fluid to be injected into the hot exhaust of the airplane creating dots or lines of smoke. Each aircraft is equipped with this machine system.

Previous systems, as discussed U.S. Pat. No. 7,082,706, required a master/slave relationship. This dependent relationship requires inter-plane communication systems and some proximity to each other in order to facilitate those communications. This limits the size and scope of the aerial message. This application machine system removes the master/slave relationship, freeing the aircraft up from any required inter-plane communication what so ever.

With each aircraft not dependent on any other aircraft to operate, the system can be used by separate aircraft that are far apart, even miles apart, negating the need to fly close enough for wireless based master/slave systems.

By removing the dependency on the wireless technology, aircraft can be miles apart, and come together from different directions, to build a message or design of any kind. This greatly enhances the “cool factor” of those watching and increases the value of the entertainment and advertising.

With each aircraft able to operate independently, no single aircraft is required to control the other. By removing the master/slave relationship limitation of previous systems, as discussed U.S. Pat. No. 7,082,706, any aircraft can be flown in any position of flight, and there is no requirement for a master aircraft to be flown with special equipment. Any aircraft, with this machine system installed, can be used to fly any position.

Aircraft being mechanical devices, they are susceptible to maintenance issues, both on the ground and in the air. By removing the master/slave requirement, at no time is the system dependent on one aircraft, or one aircraft with special equipment. Any aircraft can fly any position, and any flight profile.

Previous systems failed to solve the problem of being able to create advanced aerial designs, or going beyond just messages with words. With the use of onboard computer systems, integrated GPS systems, EFIS (Electronic Flight Information Systems), and autopilots, the ability to create complex shapes and designs becomes possible. This integration takes the aerial messaging system to a whole new level of entertainment and marketing value.

### Advantages

No requirement of a master or slave computers
No requirement of wifi communications systems
No inter-plane communications requirements
Ability of planes to fly far apart
Ability of characters and designs to come together from all directions
No requirement of one single master aircraft
Ability to be flexible, changing pilots and positions in real time
Ability to create advanced aerial designs
No requirement to fly formation
Ability to integrate GPS, EFIS, Autopilot and other systems to ease pilot workload, improve safety and create advanced designs

These and other advantages of one or more aspects will become apparent from a consideration of the ensuing description and accompanying drawings.

### SUMMARY

In accordance with one embodiment, this application of an aerial machine messaging and design system consists of a computer, GPS, relay switch, fluid solenoid switch, fluid, fluid pump, check valve, and fluid injector. The purpose of the system is to allow multiple aircraft to deliver puffs of smoke in the air, independently, without regard to the other, to deliver aerial messages and designs. The computer controls the relay switch. When the switch is activated, the switch opens the fluid solenoid, allowing fluid to be injected into the hot exhaust of the airplane creating dots or lines or puffs of smoke. Each aircraft is equipped with this machine system. The key to this system is the computer integration of other systems determining when and where to place the puffs of smoke.

Removing the inter-plane wireless communication systems requirement, as well as the master/slave relationship of prior art, frees the aircraft to fly independently and autonomously without regard to the other. Integrating GPS systems with accurate time and position, and other advanced flight systems, opens up a whole new level of aerial messaging and design opportunities increasing its marketing and entertainment value.

### DRAWINGS AND FIGURES

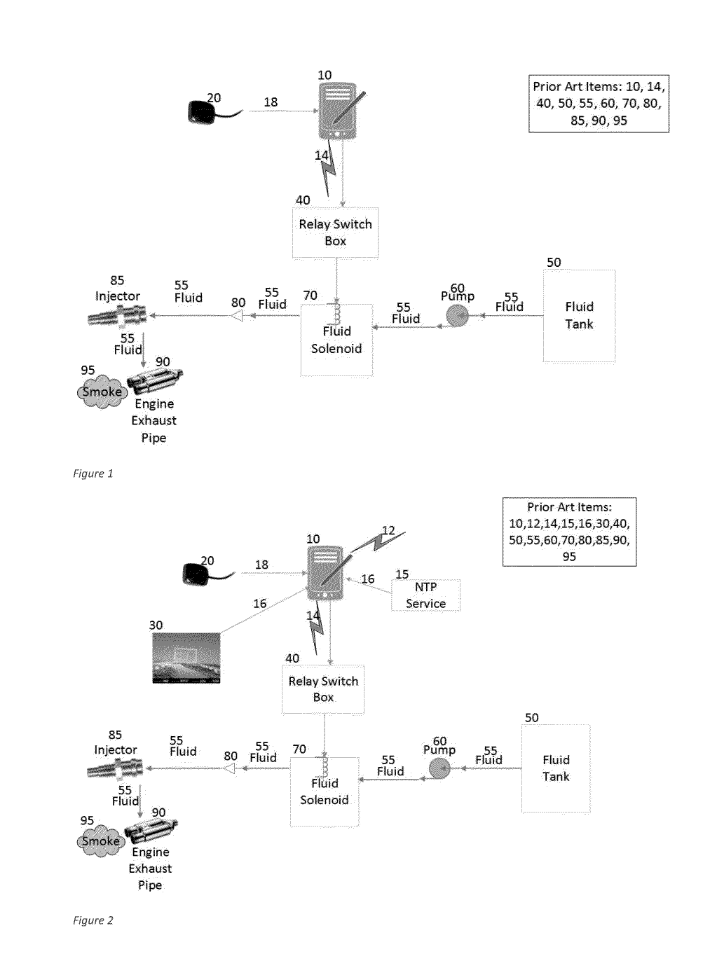

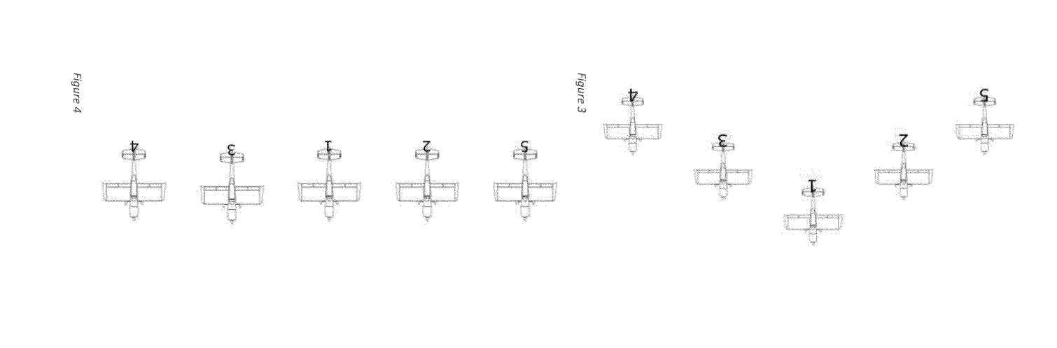

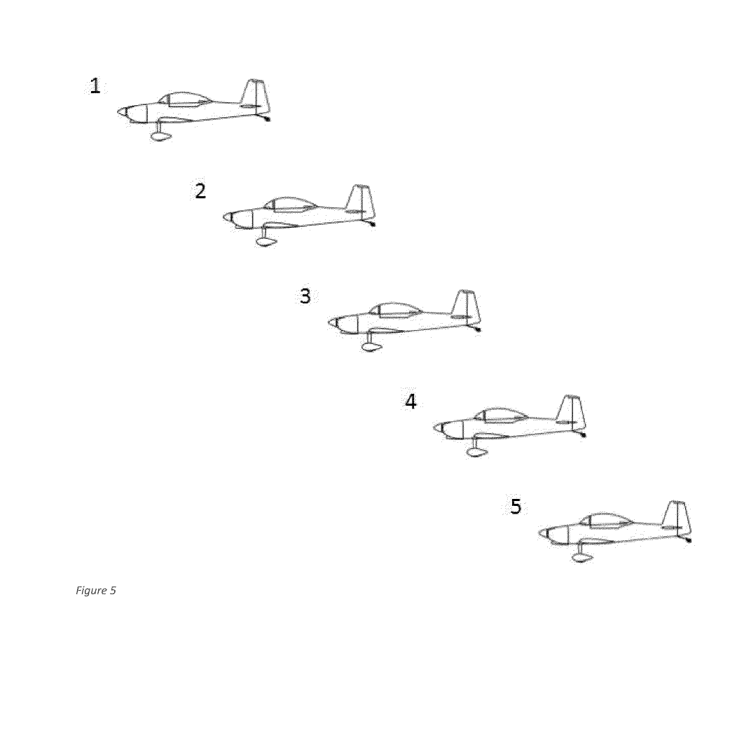

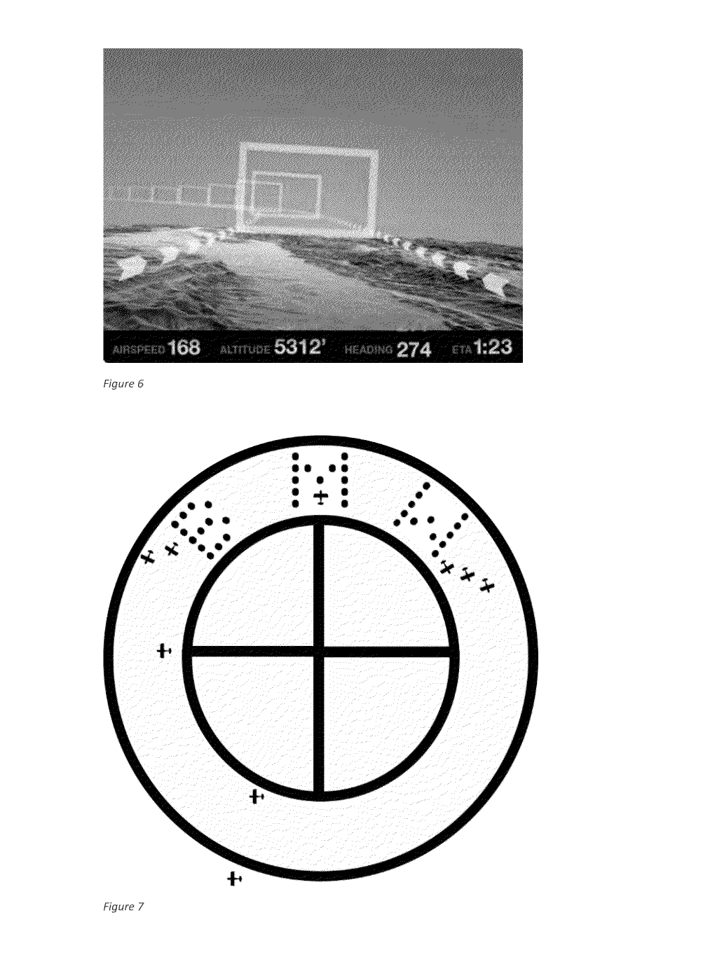

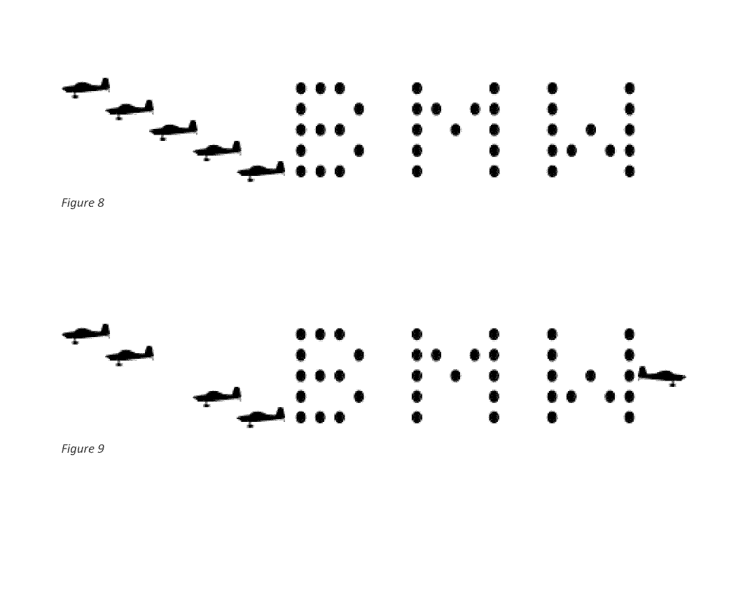

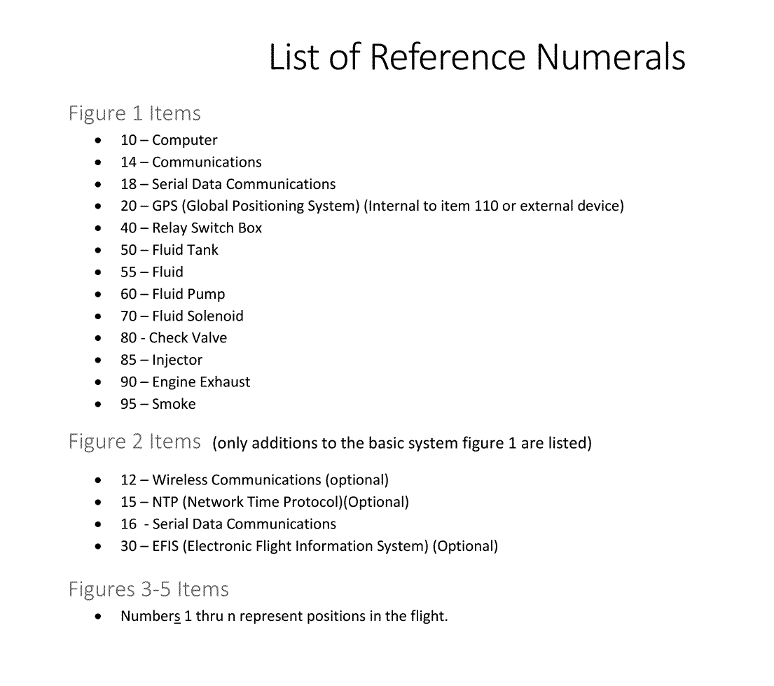

Drawings for the machine system are included in the Drawings. For reference purposes, when referring to an item in a figure, the first number refers to the figure number, and the next 2 numbers refer to the item in that figure. Example: Item 120 refers to FIG. 1 item 20.

### BRIEF DESCRIPTION OF FIGURES

FIG. 1 contains the overall view of the basic system and components of the first embodiment of my invention. It consists of the components necessary to deliver the aerial messaging system.

FIG. 2 contains the basic system with additional optional equipment as my second embodiment. It consists of all of the items from FIG. 1, and includes additional items that will improve the system with additional features.

FIG. 3, a typical VIC formation flown by pilots

FIG. 4, typical Line Abreast Formation flown by pilots

FIG. 5, Typical Trail Formation flown by pilots

FIG. 6 EFIS HITS (Highway in the Sky). A view of an Electronic Flight Display System

FIG. 7 complex design example.

FIG. 8 Message Trail Formation and flown in reverse

FIG. 9 Message trail formation and one plane not in formation

### DETAILED DESCRIPTION

### FIG. 1

### First Embodiment

One embodiment, the most basic of the system is illustrated in FIG. 1. The basic system consists of various components that will allow a flight of aircraft to create aerial messages and designs in the air using smoke generating systems. This stand-alone complete system would be in each aircraft.

The heart of the system is item 110 the computer. The computer contains software for programming and interfacing with other devices for the system to work. The preferred device is an Android based device. This device is preferred due to its low cost, reliability, user interface, built in communication layers, high availability, and long life expectancy. While this is the preferred device, any computer could be used to serve the required computing functions. All programming of the system can be done through the computer interface.

Item 114 is a communication layer between the computer and item 140 relay switch box. The preferred communication layer is wireless Bluetooth. While this is the preferred method, any communications layer, wired, or wireless, can be used. This communications layer is used to communicate with the relay to turn a switch on and off.

Item 120 is a GPS (Global Positioning System). GPS is at the heart of the system and provides numerous pieces of data to the computer. The GPS provides real-time 3-dimensional position, navigation, and timing world-wide. Position and time are key elements to the system. While the preferred method is a separate GPS device with wired or wireless communications to the computer, an internal GPS to the computer can also be used as well as GPS data from any other source.

Item 118 is the data communications link between item 120 GPS and item 110 computer.

Item 140 is the relay switch box. Signals from the computer activate/deactivate a relay switch.

Item 150 is the fluid tank. The fluid tank holds fluid to make smoke.

Item 155 is the fluid. The preferred fluid is a paraffin based mineral oil that is non-toxic, biodegradable, and environmentally friendly. Other fluids are also suitable.

Item 160 is the fluid pump. The fluid pump pumps the fluid from the item 150 tank to the item 170 fluid solenoid.

Item 170 is the fluid solenoid. The item 170 fluid solenoid is open/closed from a signal from the relay box. When the fluid solenoid is open, it allows fluid to flow from the 160 pump, to the item 180 check valve.

Item 180 is the check valve. The check valve is a one way valve that prevents back flow of the fluid and only allows fluid to flow in one direction. The check valve also aids in improving the crispness of the smoke start and stop points.

Item 185 if the injector. The injector is attached to the item 190 engine exhaust and is designed to spray the fluid into the item 190 exhaust to be atomized.

Item 190 is the engine exhaust.

Item 195 is the smoke generated by the fluid being injected into the engine exhaust.

### FIG. 2

### Second Embodiment

FIG. 2 contains the second embodiment of my system. It contains all of the same items as the basic system in FIG. 1, with the addition of the following items.

Item 212 is an optional wireless inter-computer WIFI communication layer. This communications layer allows for data transfer between the computers to ease the workload of data entry of what is to be done in the air. While all programming can be done through the computer interface and no wifi interconnect is required, having this wifi connectivity saves time, data entry errors, and improves ease of use.

Item 215 is an optional NTP (Network Time Protocol) software service that provides time synchronization to the computer. This software can be running on another computer installed in the aircraft, or can be running as a software service on the computer. This is simply an optional software service to provide accurate time to the computer. Accurate time to +−10 ms is critical to the system function accuracy.

Item 216 is an optional data communications link between the computer and item 230 EFIS System.

Item 230 is the optional EFIS (Electronic Flight Information System.) An electronic flight instrument system (EFIS) is a flight deck, in cockpit instrument display system, in which the display technology used is electronic rather than electromechanical. EFIS displays in aircraft provide graphical representations and interfaces into aircraft systems to include air data, GPS, engine monitoring, autopilot, flight directors, instrument approach systems, communication systems, and other advanced integrated systems. EFIS systems also provide communication data links to other systems which allow for integration from external devices to the EFIS. Notably in this system, data from item 110 computer can be sent to the EFIS that allows the EFIS to generate HITS (Highway in the sky) navigation display, autopilot integrations, and other useful systems integration features. EFIS systems are prior art. What is unique and novel is the integration of the EFIS to the aerial display system to all for complex shapes and designs, autopilot integration, HITS (Highway In The Sky) integration, and other useful integration features.

### Operation

Below describes one method for operating the aerial display system. The computer requires information input into the computer in order for the system to correctly deliver the proper smoke at the proper location at the proper time. Each aircraft system operates completely autonomously, without regard to the other. So the computer needs to know who (which airplane) is doing what (flying what message or design). Below describes a typical flight operation to deliver an aerial message or design.

I start by gathering the pilots on the ground. Each pilot has their computer in their hand. I detail to each pilot what we are to display, what their flight position is, the number of aircraft in the flight, and other important details of the flight so that each computer can be configured properly. Each pilot enters this information into their individual computer. The ground portion of the flight is complete. The computer now has the information it needs to activate the smoke.

Next the pilots get into their planes and start their planes. They connect their computer to their plane. The computer begins communicating with various systems in the plane: The GPS, the relay box, and other optional equipment. The plane is now ready.

The pilots take off and position their aircraft in the air to the desired location for the aerial display. Once the planes are in the desired position, the lead pilot tells the other pilots over the radio, “Arm your system.” Each pilot arms their system through their computer screen. Now the computer, at the time and location programmed, begins executing by sending on/off signals to the relay box at the proper time using GPS position, time, speed and other flight data information. The relay box turns the fluid solenoid on/off. Fluid from the fluid tank, flows through the pump, through the solenoid, though the injector, through the exhaust, and into the air, making smoke. The computer turns the relay on/off at the proper time, interrupting the fluid flow with the solenoid, starting and stopping the smoke in the air. The key to this system is that since all the computers operate independently, without regard to the other, the planes can fly whatever flight path they choose. The planes can be separated miles apart, even out of sight of each other, and can come together at any time to build design, shapes and messages. Since there is no requirement for inter-plane communication as required in prior art, no master/slave relationship as required in prior art, the planes are free to move about the sky at their discretion, without being tethered by an inter-plane communication system found in prior art. The integration of GPS, and the computer, creates many advantages over prior art:

No Inter-Plane Communication Required.
Having the computer in each aircraft determining when to activate the smoke, removes the master/slave relationship limitation found in prior art. No inter-plane communication what so ever is required.

No Formation Flying Required.
Integration of the GPS to the computer, removes the requirement of the planes flying in formation to deliver an aerial display or message. The computer, using the GPS, and its programming, knows where the plane is, where the plane wants to go, and when to turn the smoke on and off. Since no formation is required, the pilots increase safety and situational awareness when using this aerial display system. They can fly at any altitude and flight path that is programmed. This increases pilot situational awareness, improves safety, and reduces fatigue, among other positive impacts.

Flying any Flight Path.
By removing the inter-plane communication, and the requirement to fly in formation, the planes are free to fly any flight path at all. This opens up the opportunity to create complex designs and shapes far beyond just messaging systems used in prior art.

Fly any Speed, Changing with Conditions.
With the integration of GPS with the computer, pilots can fly at any speed in any aircraft. The computer can instantly adjust to the speeds and conditions being flown.

3 Dimensional Designs Become Possible.
FIG. 7 shows a sample design that can be created with the machine system. With the integration of GPS with the computer, pilots are no longer required to fly in formation as in prior art. They can fly at any altitude and flight path that is programmed. Complex shapes and designs in 3 dimensions can be flown accurately and the computer can make adjustments to the smoke based on speed and position. This ability to create complex shapes changing speeds, altitudes, and position, brings a completely new level of marketing and entertainment value to the aerial messaging system, not found in prior art.

Messages and Designs can be Flown from any Direction in any Formation, or not in Formation.
Prior art often required that the planes be flown from left to right at high altitudes, so that spectators can look up and read the words. FIG. 8 shows how this system allows for some new and exciting message and design development:
   Planes can be flown left to right above the spectators creating the first character first as in prior art.
   Planes can be flown in a line abreast formation as in FIG. 4, or vic formation FIG. 3 as in prior art. This system also allows for the planes to be flown in trail as in FIG. 5. What this allows is a whole new vertical messaging system to be flown down low in front of a crowd, with the message to be shown vertically, right in front of the spectators. Prior art limited messages to be flown overhead in order to be read by spectators looking up. With the planes flying in trail formation, the message is built vertically shown to the spectators like a billboard, as shown in FIG. 8. This gets the message down low and “in their face”, increasing the impact of the message and its value.
   Planes can be flown from right to left, as shown in FIG. 8, building the last character first, adding more mystery and interest to the message development, improving its value.
   Planes can be flown in formation, or not in formation, as shown in FIG. 9. One aircraft is shown flying head-on into the other 4 aircraft. While the output of the message is the same as in FIG. 8, the ability of the planes to fly head on into each other, creates excitement and increases the impact of the message to the spectators. The integration of the GPS with the computer, makes smoke placement and the accurate timing of smoke dots possible, to include complex head on maneuvers like this. Flight paths can be curved or straight, flown level or with a change in altitude.
   Messages can be flown at low level, in a “photo type pass”, where the spectators can see the top of the planes as they fly by in a banana type pass, and can be done from left to right, or right to left. The computer system automatically makes the required timing and position changes to the smoke to accomplish this task for readability.

Multiple Simultaneous Objects.
With each aircraft operating independently, several objects, characters, and sentences can be built at the same time, in different locations, at the same time, seemingly unrelated, until the objects and characters are complete. This allows for multi sentence, multi-object, simultaneous development of display objects as shown in FIG. 7. In FIG. 7, 3 aircraft are flying one direction to create the message. 2 aircraft are flying the opposite direction to complete the message. While that is going on, 2 aircraft are creating the perpendicular lines in the middle of the design, and 2 aircraft are creating the rings of the design. This becomes an “aerial dance” so to speak, that is interesting to watch develop, creating a higher marketing and advertising value.

Languages.
While the prototype was built using the English language as a character set, any language of any character set can be built into the system to create messages in any language.

Scalability.
With each aircraft operating independently, now not limited by inter-plane communication systems found in prior art, any number of aircraft can be used and flown to create characters and objects. Flights of 5, 6, 7, 8, and 9 planes were used in the prototype machine. FIG. 7 shows how 8 planes can simultaneously fly messages and designs, flying in different directions, in formation, and not in formation, to create a design. Since no aircraft is dependent on the other to create smoke at the proper time and place, then the planes can begin miles apart, without regard to the dependencies and limitations of inter-plane communication found in prior art.

Manned or Unmanned.
The aircraft flying the message or design can be manned, or unmanned.

### DESCRIPTION AND OPERATION OF ALTERNATIVE EMBODIMENTS

FIG. 2 represents the second embodiment of my invention which adds additional equipment and systems that improve system ease of use, programming, system accuracy, and integrate into aircraft systems that allow for additional aerial designs and aerial messaging options not available in the basic system.

The item 230 EFIS is prior art. These EFIS systems bring electronic integration into the cockpit for pilots to improve situational awareness, computer display, autopilot integration, HITS (Highway in the Sky) display and other very unique features. My preferred integration is with the EFIS GPS system and Autopilot, but other system integration options are readily available that improve the system accuracy, safety, and ease of use.

The computer is already GPS position aware. It knows where the plane is and where it wants the plane to go to deliver its aerial design or message. It can send that information over the communications link and tell the EFIS where it wants the plane to go. EFIS systems are already equipped to take external data sources to display direction and desired flight path. When the computer sends a desired flight path to the EFIS, the EFIS can display that flight path on the EFIS screen giving a visual reference to the pilots where to fly with a HITS representation, or some other graphical depiction of flight path desired. FIG. 6 shows a sample of a HITS flight path display. Integration of the computer to an EFIS system provides several valuable improvements over prior art:
Availability of GPS data from the EFIS removes the need for a GPS device attached to the computer.
EFIS GPS data is typically designed to be more accurate and has higher refresh rates which improves the accuracy of the computer and the entire aerial messaging system thus making GPS data from the EFIS usually more desirable that that of a portable GPS or a GPS built into a portable device.
Having the EFIS display gives the pilot a HITS display as shown in FIG. 6, relieves the pilot from staring at another aircraft to fly formation. Further, the HITS display accuracy is far better than a pilot can fly manually looking at another plane that may be hundreds, or even thousands of feet away. The ability of a pilot to fly a HITS flight path significantly improves the accuracy of that planes position in the sky.
Flying formation by hand is tiring and fatiguing to the pilot. Safety of the flight is compromised over time. Having the EFIS system automatically fly the desired flight path delivered by the computer, using the autopilot, significantly improves the safety of the flight, and the accuracy of the display. An autopilot system can fly a much more accurate flight path than a human pilot can.
Having GPS integrated HITS display removes the requirement of being in formation all together. It no longer is necessary that the pilot flies a perfect formation, or any formation at all, as has been required in prior art. The computer system knows where it is and what to do without any regard to any other aircraft.
EFIS systems provide integration into other useful systems like airborne traffic, terrain, weather and other important safety features that increase safety and situational awareness to the pilot not provided in prior art. As an example, prior art required pilots to watch intently the plane next to them while flying formation. They are not looking around for other hazards like other planes. This can be dangerous. The EFIS can alert the pilot to the danger, switch off the computer, and cease aerial operations until the danger is gone.

### CONCLUSION, RAMIFICATIONS, AND SCOPE

Accordingly, the reader will see that this aerial display machine system of the various embodiments can be used to provide a completely new level of advertising, marketing, and messaging system value that before was difficult or impossible to attain. By removing the master/slave requirement of prior art, and integrating GPS and other systems to the computer we get the following benefits summarized:
No inter-plane communication requirement
No formation flying required
Ability to fly any flight path
Ability to fly any speed
3-dimensional designs become possible
Multiple Simultaneous objects
Multi-language
Scalable for the use of many aircraft
Messages and designs can be flown from any direction
EFIS integration brings new functionality and performance capability with HITS and autopilot integration
Systems integration brings increased safety and situational awareness to the pilots and planes

Although the description above contains many specificities, these should not be construed as limiting the scope of the embodiments but as merely providing illustrations of some of the presently preferred embodiments. Some examples of this are:

### The Computer

The computer can be of any computer type such as a phone, tablet, laptop or any other computer device. Any computer device can be used if it contains the proper software to control the relay switch.

### Software

The software running on the computer is designed ultimately to determine when to activate the relay switch. Any software on any platform can be used.

### GPS

The purpose of the GPS is to provide accurate position, speed, and time information to the computer. The position, speed, and time information is used to make calculations in the computer to help the computer software to determine when to activate the relay switch. The GPS can be a separate device, or integrated into the computer.

### Relay Switch

The relay device can be wireless or wired to the computer. The relays function is to take commands from the computer, and activate one or more switches. When the switch is active, it activates the fluid solenoid allowing fluid to flow to the exhaust. Any suitable relay switch device capable of taking commands from computer device is suitable.

### Fluid Solenoid

The fluid solenoids function is to allow, and disallow, fluid flow to the injector. Any suitable fluid solenoid can be used.

### Fluids

Any number of fluids can be used in the system to create different outputs of the system. While the prototype used a paraffin based oil to create white smoke, any number of fluids can be used to create different desired output types of color, texture, and density

### Check Valve

The function of the check valve is to prevent backflow of fluid when the solenoid is closed as well as improve the crispness of the smoke on and off. This device can be eliminated or duplicated.

### Injector

The function of the injector is to spray fluid into the hot exhaust to atomize the fluid. Any device capable of allowing fluid flow into the exhaust is suitable.

### Data Communication Layers

The data communication types can be of any type. For example, communications can be of WIFI, Bluetooth, wired, serial, radio frequency, or any other data communications type.

Thus the scope of the embodiments should be determined by the appended claims and their legal equivalents, rather than by the examples given.

Previous systems, as discussed U.S. Pat. No. 7,082,706, required a master/slave relationship. This dependent relationship requires inter-plane communication systems and some proximity to each other in order to facilitate those communications. This limits the size and scope of the aerial message. This application machine system removes the master/slave relationship, freeing the aircraft up from any required inter-plane communication what so ever.

With each aircraft not dependent on any other aircraft to operate, the system can be used by separate aircraft that are far apart, even miles apart negating the need to fly close enough for wireless based master/slave systems.

By removing the dependency on the wireless technology, aircraft can be miles apart, and come together from different directions, to build a message or design of any kind. This greatly enhances the “cool factor” of those watching and increases the value of the entertainment and advertising.

With each aircraft able to operate independently, no single aircraft is required to control the other. By removing the master/slave relationship limitation of previous systems, as discussed U.S. Pat. No. 7,082,706, any aircraft can be flown in any position of flight, and there is no requirement for a master aircraft to be flown with special equipment. Any aircraft, with this machine system installed, can be used to fly any position.

Aircraft being mechanical devices, they are susceptible to maintenance issues, both on the ground and in the air. By removing the master/slave requirement, at no time is the system dependent on one aircraft, or one aircraft with special equipment. Any aircraft can fly any position, and any profile.

Previous systems failed to solve the problem of being able to create advanced aerial designs, or going beyond just messages with words. With the use of onboard computer systems, integrated GPS systems, EFIS (Electronic Flight Information Systems), and autopilots, the ability to create complex shapes and designs becomes possible. This integration takes the aerial messaging system to a whole new level of entertainment and marketing value.

### Advantages/Disadvantages

### Advantages

### Autonomy

With each aircraft not dependent on any other aircraft to operate, the system can be used by separate aircraft that are far apart, negating the need to fly close enough for wireless based master/slave systems.

By removing the dependency on the wireless technology, aircraft can be miles apart, and come together to build a message or design of any kind. This greatly enhances the “cool factor” of those watching and increases the value of the advertising.

With each aircraft able to operate independently, no single aircraft is required to control the other. By removing the master/slave relationship limitation of previous systems, any aircraft can be flown in any position of flight, and there is no requirement for a master aircraft to be flown with special equipment. Any aircraft, with this system installed, can be used to fly any position.

### Computer Controlled

By using a computer controlled system, completely new and innovative flight paths can be flown. Formations of line abreast, Vic, and trail can be used. With the integration of GPS, planes need not even be in formation at all, which is required by previous systems. Planes not in formation can fly a path dictated by GPS technology, and be in a 3 dimensional space, flying at different altitudes, even flying at each other head-on, to build the message or figure.

With the integration of an optional EFIS system, the pilot can fly a flight path dictated by the EFIS system by visually looking at a “highway in the sky” graphical presentation. The pilot merely watches a computer display, flying through the boxes, similar to a landing system, where the boxes show him where to go. With the integration of the Aerial Display System with an EFIS system, the ability to make very complex shapes and designs possible in a 3 dimensional space.

### Multiple Simultaneous Objects

With each aircraft operating independently, several objects, characters, and sentences can be built at the same time, in different locations, at the same time, seemingly unrelated, until the objects and characters are complete. This allows for multi sentence, multi-object, simultaneous development of display objects.

### Various Flight Speeds

With the use of GPS, various speeds can be flown and the system is able to make adjustments to the dots and lines as a result of the change in speed. This allows for the system to be used in many different types of aircraft that have different speed ranges. Speeds tested in the prototype ranged from 50 knots to 200 knots. Bench tests showed successful operation of speeds from 1 knot to 900 knots. With the integration of GPS, flight speed is no longer a limiting factor. The computer can make instant adjustments based on GPS speed.

### Position Accuracy

With the use of GPS, the system can very accurately position a display exactly where the user wants it. This is a significant improvement over previous systems.

### Ease of Flight

With the integration of GPS and EFIS system, the pilot is no longer required to maintain a difficult formation position. The pilot can fly the highway in the sky graphical presentation on the screen which is much simpler to do, particularly for long durations or complex objects.

### Software Upgrade Ability

With the simplicity of application update ability with small computers, new features and enhancements can be developed and tested easily

### Disadvantages

### GPS

Reliance on the GPS system means that the GPS must have clear view of the sky at all times to operate. If the sky becomes obscured, or the GPS signal becomes weak or fails, the system becomes non-functional.

### User Input

Since the system relies on user input for accuracy of the message or object to be displayed, any errors of user input can result in a object that is unreadable or unrecognizable.

### Cost

Each aircraft requires the computer and relay switch to operate.

### Ease of Use

Previous systems did not require much interaction from the pilot. The Master/Slave relationship allowed the pilot to focus on his flying job, and not so much the messaging system. This system requires more pilot interaction. The increased complexity of the system and its ability, requires system training and additional safety attention to detail.

I claim:

1. A method for delivering aerial messaging and designs compromising:
a. A computer.
b. A GPS global positioning system.
c. A first means for communicating with said GPS.
d. A relay switch box.
e. A second means for communicating with said relay switch box.
f. A fluid tank.
g. A fluid pump.
h. A fluid solenoid.
i. A third means for communicating with said fluid solenoid.
j. A check valve.
k. An injector.
l. An exhaust.
m. Using a plurality of aircraft.
n. Whereby said aircraft deliver messages and designs in the sky.
o. Whereby said aircraft using said method are operating independently of one another.
p. Whereby said method allows said aircraft to fly not in formation, in any direction, in any flight path, to create said messages and designs.

2. The method of claim 1, further including an EFIS, electronic flight information system, which includes:
a. A forth means for communicating with said computer.
b. Whereby the aircraft can use the EFIS display for delivering said messages and designs in the sky.
c. Whereby said aircraft may use said EFIS display to fly flight paths to create said messages and designs.
d. Whereby said aircraft my use an autopilot to fly said messages and designs
e. Whereby using said method provides increased flight safety and said aircraft separation.

3. The method of claim 1, further including inter-computer communications which includes:
a. A fifth means of communicating that allows communication between said computers.
b. A process for sending and receiving the required data for properly executing said message or design.
c. A process for error checking between said computers to ensure proper data entry information.

4. The method of claim 1, excluding said GPS, further including a process for obtaining time which includes:
a. A process for obtaining time
b. A sixth means of communication to said computer
c. Whereby said computer would receive time data from sixth means of communication
d. Whereby said aircraft deliver said messages and designs using said time data from said process

5. A machine for delivering aerial messaging and designs compromising:
a. A computer.
b. A GPS global positioning system.
c. A first means for communicating with said GPS.
d. A relay switch box.
e. A second means for communicating with said relay switch box.
f. A fluid tank.
g. A fluid pump.
h. A fluid solenoid.
i. A third means for communicating with said fluid solenoid.
j. A check valve.
k. An injector.
l. An exhaust.
m. Using a plurality of aircraft.
n. Whereby said aircraft deliver messages and designs in the sky.
o. Whereby said aircraft using said machine are operating independently of one another.
p. Whereby said machine allows said aircraft to fly not in formation, in any direction, in any flight path, to create said messages and designs.

6. The machine of claim 5, further including an EFIS, electronic flight information system, which includes:
a. A forth means for communicating with said computer.
b. Whereby said aircraft can use the EFIS display for delivering said messages and designs in the sky.
c. Whereby said aircraft may use said EFIS display to fly flight paths to create said messages and designs.
d. Whereby said aircraft my use an autopilot to fly said messages and designs
e. Whereby using said machine provides increased flight safety and said aircraft separation.

7. The machine of claim 5, further including inter-computer communications which includes:
a. A fifth means of communicating that allows communication between said computers.
b. A process for sending and receiving the required data for properly executing said message or design.
c. A process for error checking between said computers to ensure proper data entry information.

8. The machine of claim 5, excluding said GPS, further including a process for obtaining time which includes:
a. A process for obtaining time
b. A sixth means of communication to said computer
c. Whereby said computer would receive time data from sixth means of communication
d. Whereby said aircraft deliver said messages and designs using said time data from said process
